(19) United States
(12) Patent Application Publication
(10) Pub. No.: US 2006/0162421 A1
(43) Pub. Date: Jul. 27, 2006

(54) Shock indicator

(75) Inventor: Steven H. Mess, Franklin, WI (US)

Correspondence Address: WHYTE HIRSCHBOECK DUDEK S C, 555 EAST WELLS STREET, SUITE 1900, MILWAUKEE, WI, 53202, US

(73) Assignee: Brady Worldwide, Inc.

(21) Appl. No.: 11/040,085

(22) Filed: Jan. 21, 2005

(51) Int. Cl. G01N 3/30

(52) U.S. Cl. 73/12.01

(57) ABSTRACT

A shock indicator comprising: A. A base; B. A peg affixed to the base; and C. An indicating weight comprising a peg opening and a gap, the weight attached to the peg at the peg opening such that the weight cannot detach from the peg in the absence of experiencing a shock of at least a predetermined level of force. The indicator may further comprise (i) a spacer in combination with the base to form a cavity in which the indicating weight is located, and (ii) a transparent cover extending over the cavity and in contact with the spacer and peg. In one embodiment the shock indicator is multi-directional while in another embodiment, the shock indicator is unidirectional.

### FIELD OF THE INVENTION

This invention relates to shock indicators. In one aspect, the invention relates to permanent, mechanical shock indicators while in another aspect, the invention relates to shock indicators in the form of labels. In yet another aspect, the invention relates to a package bearing a shock-indicating label.

### BACKGROUND OF THE INVENTION

Many goods are sensitive to the shock that may result from a collision or impact received during storage, shipment or use. The shock may result from one or more of a number of possibilities, e.g., the dropping of the good, or its impact with another good during its shipment from a manufacturer to an end-user, or the force experienced by a good during acceleration, i.e., the force acting on a good resulting from a change in the speed of the good.

Not all shock damages all goods. Typically, some minimal level of shock must be incurred before the good is damaged but this minimal level of shock may not be readily evident from cursory inspection of the good. In these instances, some form of shock, or impact indicator is useful to inform a reader of the indicator that the good should be closely inspected for damage before installation and/or use.

Various forms of shock indicators are known. The most common shock indicators are labels or devices designed for use in the shipping industry. Representative of these devices is the shock indicator manufactured and marketed by Shockwatch of Graham, Tex. under the trademark Shockwatch®. This label incorporates a colored liquid suspended in a capillary tube. If the package to which the label is attached is subjected to a shock of sufficient force, then the liquid is discharged from the capillary tube into a transparent or translucent chamber in which the tube is situated resulting in a visible color change to the chamber.

Another shock-indicating label is the Teladrop™ manufactured and marketed by Telatemp Corporation of Fullerton, Calif. This device makes use of two weighted-mass leaf spring actuated sensors. When the package to which the label is attached receives an impact, shock or acceleration of sufficient magnitude, a weight forces the leaf spring to bend which in turn moves a bi-colored plate. The top of this plate is visible through a window located at the top of the label, and the label displays a color change from red to blue as a result of the shock. Other devices known in the art are described in U.S. Pat. Nos. 3,312,188, 3,921,463, 4,177,751, 4,237,736, 4,779,461, 6,474,133, 6,539,798, 6,633,454, and 6,712,274.

### SUMMARY OF THE INVENTION

In one embodiment of this invention, a multi-directional shock indicator is described, the indicator comprising:
A. A base;
B. A peg affixed to the base; and
C. An indicating weight comprising a peg opening and a gap, the weight attached to the peg at the peg opening such that the weight is free to at least partially, preferably fully, rotate about the peg without detaching from the peg in the absence of experiencing a shock of at least a predetermined level of force.
   The peg is typically affixed to the center of the base, and the indicating weight is suspended on the peg. The weight has an opening which is shaped and sized in such a manner that allows it to rotate freely about the peg without detaching from the peg in the absence of experiencing the predetermined level of shock, i.e., a peg opening. Once the predetermined level of shock is experienced, the indicating weight will detach from the peg. Thus a reader of the indicator will know that the indicator and the object to which it is attached, has experienced at a minimum the predetermined level of shock. The shock experienced by the indicator weight can result from impact and/or acceleration.

In another embodiment of the invention, the indicator includes a spacer that overlays the base and thus creates a cavity in which the indicating weight is contained. In yet another embodiment, the indicator further comprises a transparent cover that encloses the indicating weight within the cavity and protects it against accidental detachment from the peg. The cover can be fully or partially removable to allow resetting of the indicator, i.e., re-attachment of the indicating weight to the peg, for re-use.

In certain and preferred embodiments, the indicating weight includes a gap (or space or slit) in open communication with the peg opening. The size of this gap is one means by which to control or set the amount of force required to detach the weight from the peg. In another embodiment, a slit extends from the peg opening through the weight towards, but not to, the end distal from the peg. Optionally, this slit terminates in a second opening or aperture in the indicating weight located near the distal edge of the weight, i.e., the distal opening.

The base and indicating weight are preferably of different colors so that visual determination of whether or not the weight is still attached to the peg is easily discernable. The indicator is typically constructed of lightweight, inexpensive materials and is of such a size as to form an easy-to-use label. The side of the base opposite the side to which the indicating weight is to the peg may contain an adhesive, e.g., a pressure-sensitive adhesive, for securing the indicator to an object, e.g., a shipping package or the good itself.

In yet another embodiment of the invention, the shock indicator is a single or unidirectional shock indicator. In this embodiment, the indicating weight is not free to rotate about the peg; rather it is affixed to the peg, or positioned on the base or within the cavity of the indicator, in such a manner that it can be detached from the peg only if the minimum required shock to the indicator is from a predetermined direction. Such indicators are simpler in design, and thus can be manufactured in smaller sizes and at less cost than multi-directional shock indicators.

### BRIEF DESCRIPTION OF THE DRAWINGS

FIG. 1 shows the indicating weight used to generate the data of Table 1.

FIG. 2 shows one embodiment of an indicating weight.

FIG. 3 is a cross-sectional view of one embodiment of a shock indicator.

FIGS. 4A and 4B show a multi-directional shock-indicating label in its ready state and after it has experienced a predetermined level of shock, respectively.

FIGS. 5A and 5B show a unidirectional shock-indicating label in its ready state and after it has experienced a predetermined level of shock from a predetermined direction, respectively.

### DETAILED DESCRIPTION OF THE INVENTION

The base can be constructed of any material, and it can be of any size and shape. Materials of construction include paper (including paperboard and cardboard), plastic, thin metal (e.g., foil), and the like. Preferably the base material is lightweight, durable and easy to form, e.g., cut, etc.

The peg can also be made of any material, e.g., metal or plastic, and it typically has a cylindrical shape. The peg can be fastened to the base by any convenient method, e.g., piercing the base to form a compression fit between the peg and the base, the use of an adhesive, etc. Sufficient length of the peg remains above the surface of the base to allow the attachment and free rotation of the indicating weight. Typically and preferably, the peg is attached at or near the center of the base. One common peg is a truncated push-pin.

For multi-directional shock indicators, the indicating weight is attached to the peg in a manner that allows it to freely rotate about the peg. For unidirectional shock indicators, the indicating weight is attached to the peg in a manner that it cannot freely rotate about the peg. The indicating weight can be of any shape, but preferably the shape is such that the center of gravity of the weight is well below the peg. For multi-directional shock indicators, typically the indicating weight is of a generally wedge or pie-shape of a quarter-circle or less. The indicating weight can be made of any material and for a multi-directional shock indicator, it is typically made of a material that has a low coefficient of friction relative to the base and peg so as to maximize its free movement about the peg.

The indicating weight is attached to the peg at the peg opening (or aperture or hole) located at one end of the weight such that when the base and weight are in a vertical position, the weight is suspended from the peg and can rotate freely about it. The size of the peg opening is determined in large part by the diameter of the peg. If the weight is in the shape of a wedge, the peg opening is located at or near the apex of the wedge so that the arc of the wedge is distal from the peg. The weight contains a gap (or cut-out) that is adjacent the peg and is in open communication with the peg opening. If the weight is in the shape of a wedge, then the gap is located at the apex or tip of the wedge. The size of this gap can vary from a slit to a notch, and it is the primary means by which to control or set, i.e., to predetermine, the level of shock required to detach the weight from the peg.

In one embodiment of the invention, a slit is in open communication with both the peg opening and the distal opening, the latter located near the arc edge of the weight (assuming a wedge-shaped weight; if not a wedge-shaped weight, then the edge of the weight distal from the peg). This distal opening, as well as the peg opening, can be of any shape, e.g., circular, elliptical, polygonal, etc., although it is preferably circular. The length and width of the slit and the size of the distal opening can vary widely, and they are typically adapted to accommodate the shock level desired for detaching the weight from the peg.

As noted above, the level of shock required to detach the indicating weight from the peg can be controlled in one or more ways. The closer the width of the gap at the apex of the weight is to the diameter of the peg, the easier the weight will detach from the peg. Conversely, the smaller the gap, the more difficult it is for the weight to detach from the peg. The presence or absence of a slit running from the peg opening into the body of the weight also impacts on the size of the force necessary to detach the weight from the peg. Similarly, if the slit is present, then its length and width can influence the level of shock necessary to detach the weight from the peg, as well as the presence or absence of a distal opening, and if present, its size and shape.

Another factor that influences the shock level necessary to detach the indicating weight from the peg is the spring force of the material from which the indicating weight is constructed. By changing the distance between the peg opening and the edge of the indicating weight distal to the peg, the force needed to open the gap larger than the diameter of the peg can be changed. The more material in the weight, the more spring force and thus the more difficult it will be for the weight to detach from the peg. The slit in the indicating weight from the peg opening will modify, i.e., reduce, this spring force. In one embodiment, the indicating weight is designed to have the slit terminating at the distal opening that will limit crack propagation of the slit.

The total mass of the indicating weight also influences how much force is needed to actuate the shock indicator, i.e., detach the weight from the peg. A heavy object traveling at the same velocity will have more momentum than a lighter one. Thus a heavier indicating weight will come off the peg easier with a sudden shock, e.g., quick drop in velocity, due to the greater force needed to stop an object with greater momentum.

In those embodiments in which the shock indicator comprises a cavity, the indicating weight is located within the cavity. For multi-directional shock indicators, the placement of the indicating weight within the cavity is such that the weight can rotate at least partially about the peg, preferably 360° about the peg. This rotational feature of the indicator allows it to be actuated in any of a number of different positions in the X, Y plane when mounted vertically to an object, i.e., when the indicating weight is suspended, i.e., hangs free, from the peg. For unidirectional shock indicators, the placement of the indicating weight within the cavity, or the size and shape of the cavity relative to the indicating weight, is such that the indicating weight cannot rotate or otherwise substantially move about the peg.

The indicating weight can be manufactured by precision die cutting from a variety of suitable materials, including various paper products, rigid plastics and metals with proper temper. It can also be injected molded to form rigid plastic parts. The package, e.g., base plus spacer, that houses the indicating weight can be manufactured by molding the base and spacer, and, optionally, peg, as one piece and adding a transparent cover to the top of the spacer and a pressure sensitive adhesive to the bottom of the base. In another embodiment, the base, peg, spacer and cover are combined in a clam shell-design such that the cover can fold over and be locked with the base or spacer. In those embodiments of the invention that include a cover, preferably the cover is in contact with the top of the peg so as not to allow the indicating weight to come off the peg by slipping over the top of the peg.

In another embodiment in which the shock indicator comprises a cover, the cover is at least partially removable so as to allow the indicating weight to be re-attached to the peg after weight has been actuated. In yet another option, the indicating weight is held in place (i.e., secured against actuation) by means of a pin inserted through the indicating weight and into the base. If the shock indicator comprises a cover and/or the weight comprises a distal opening, the pin can pass through both and into the base. This allows shipment or other movement of the indicator without premature actuation. When the indicator is ready for use, the pin securing the weight to the peg is simply removed.

The shock indicators of this invention can be made to any size, the actual size a function of their ultimate end use. Typically, the indicators are used as labels and as such, they are made relatively small, e.g., a thickness of about 0.030 inches with a footprint of about 0.75 by 0.75 inches. Different materials will allow for different sizes and properties.

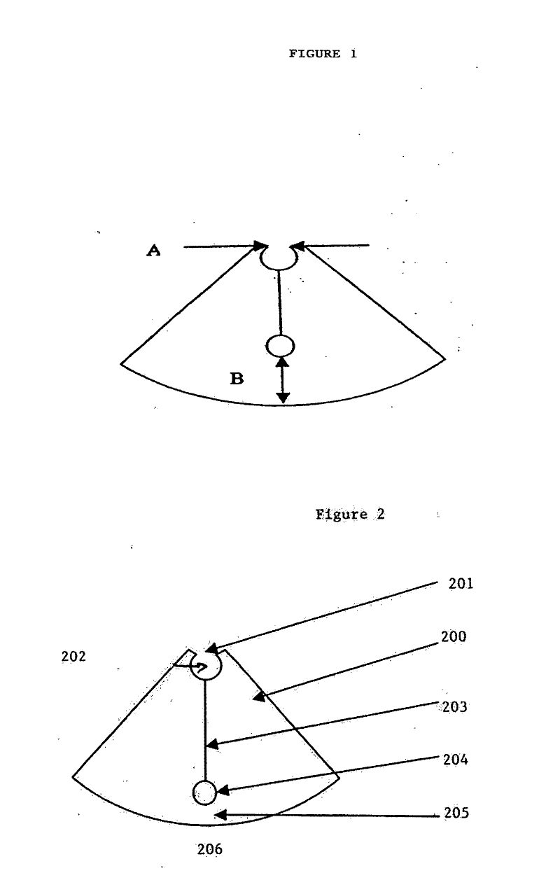

In one embodiment, shock indicator labels were prepared using 0.010-inch polyethylene terephthalate. The peg had a diameter of 0.062 inches. By varying the gap width and the distance between the peg opening and the distal edge of the weight, different shock levels (as measured by drop height) could be achieved. FIG. 1 shows the shape and measured dimensions of the indicating weight, and Table 1 reports dimensions and the shock level required to detach the weight from the peg. The weights were approximately the size of one quarter of a 0.9 inch diameter circle. The weights were hung from a cylindrical 0.062 inch diameter metal peg that was affixed to a 0.020 inch thick rigid vinyl base. A spacer layer made from 0.020 inch thick rigid vinyl was attached to the base by means of a double-sided pressure-sensitive adhesive. This drop-indicating label was attached by pressure-sensitive adhesive to the face of a 2.5×5×0.75 inch plastic test fixture. Fins were added to this fixture to guide it consistently down a 3-inch internal diameter polyvinylchloride pipe. The test fixture was dropped down the pipe from various heights onto a concrete patio block. The approximate height at which the indicating weight fell off the peg was recorded.

The gap width (A) and the distance between the lower edge of the indicating weight to the slit (B) were measured on a coordinate measuring machine. The force to pull the weight off of the 0.062 inch metal peg was measured by attaching the weight by means of a string to a load cell. The load cell was attached to a movable crosshead and the peg was affixed to a stationary grip. The weight was pulled off the peg at 0.5 inch/minute with the peak force being recorded.

TABLE 1
Predetermination of Shock Level

| | Indication height (ft) | | | |
|---|---|---|---|---|
| | 4 | 4 | 3 | 3.5 |
| A(in) | 0.0398 | 0.0362 | 0.0380 | 0.0325 |
| B(in) | 0.0708 | 0.0698 | 0.0569 | 0.0565 |
| Mass (g) | 0.0258 | 0.0256 | 0.0217 | 0.0220 |
| Gram force to pull off .062″ peg | 53.3 | 53.2 | 34.5 | 41.5 |

FIG. 2 shows one embodiment of an indicating weight. In FIG. 2, indicating weight 200 has a gap 201 that is in open communication with peg opening 202. The diameter of peg opening 202 is slightly larger than the diameter of the peg (not shown) about which it is designed to fit, and the size of gap 201 is slightly smaller than the diameter of the peg upon which it is designed to rest. Slot 203 runs vertically down the body of the weight starting from peg opening 202 and terminating at distal opening 204. The material 205, i.e., that part of the weight between distal opening 204 and arc edge 206, contributes to the control of the amount of shock force the weight will withstand before falling off the peg.

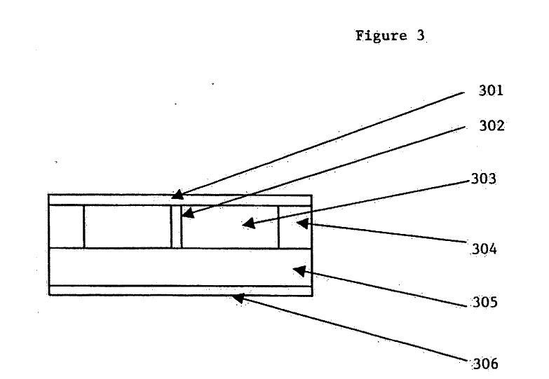

FIG. 3 shows a cross section of one embodiment of a multi-directional shock indicator of this invention. Base 305 has a pressure sensitive adhesive 306 laminated to one side and a spacer 304 laminated to the opposing side. Spacer 304 creates cavity 303, and peg 302 is affixed within the center of cavity 303 to base 305. An indicating weight (not shown) would be attached to the peg as described above such that it can rotate freely about the peg and within the cavity. Transparent layer 301 covers the entire package, preferably in contact with the top of peg 302. In an alternative embodiment not shown, one or more components of the indicator could be a one-piece, molded part, e.g., base 305, spacer 304 and peg 302 could be molded in an integrated unit.

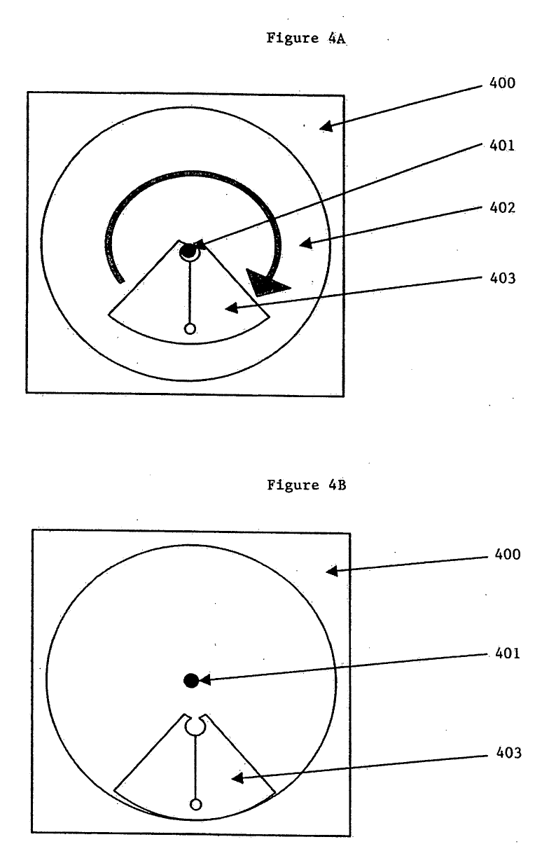

FIG. 4A shows a multi-directional shock indicator 400 in its ready state. Indicating weight 403 is hanging or suspended from peg 401. Indicating weight 403 is free to rotate 360 degrees about peg 401 within cavity 402. If less than 360 degrees of rotation is desired for whatever reason, cavity 402 can be reduced in one dimension, e.g., height, (not shown) such that indicating weight 403 can rotate only an amount less than 360 degrees, e.g., 180 degrees.

FIG. 4B shows shock indicator 400 after indicating weight 403 has been activated, i.e., released from peg 401. A shock indicator in this state reports that the indicator has experienced a shock force at least as great as the predetermined amount of shock force necessary to detach the weight from the peg.

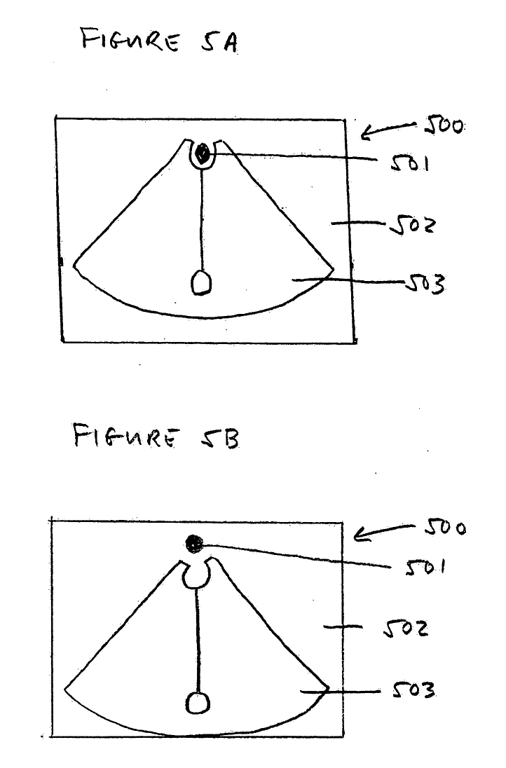

FIG. 5A shows a unidirectional shock indicator 500 in its ready state. Indicating weight 503 is hanging or suspended from peg 501. Indicating weight 503 is not free to rotate or otherwise move about peg 501 due to the size and placement of weight 503 relative to the size and shape of cavity 502. As such, indicating weight 503 will not detach from peg 501 in the absence of sufficient force to indicator 500 from the predetermined direction. FIG. 5B shows shock indicator 500 after indicating weight 503 has been activated.

Although the invention has been described in considerable detail through the preceding embodiments, these embodiments are for the purpose of illustration. Many variations and modifications can be made by one skilled in the art without departing from the spirit and scope of the invention as described in the following claims. All U.S. patents and allowed U.S. patent applications cited above are incorporated herein by reference.

What is claimed is:

1. A multi-directional shock indicator comprising:
A. A base;
B. A peg affixed to the base; and
C. An indicating weight comprising a peg opening and a gap, the weight attached to the peg at the peg opening such that the weight is free to at least partially rotate about the peg without detaching from the peg in the absence of experiencing a shock of at least a predetermined level of force.

2. A multi-directional shock indicator comprising:
A. A base;
B. A peg affixed to the base; and
C. A wedge-shaped indicating weight comprising a peg opening and a gap, the weight attached to the peg at the peg opening such that the weight is free to at least partially rotate about the peg without detaching from the peg in the absence of experiencing a shock of at least a predetermined level of force.

3. The indicator of claim 1 in which the peg is affixed to the center of the base.

4. The indicator of claim 1 further comprising a spacer attached to the base, and forming with the base a cavity within which is located the indicating weight.

5. The indicator of claim 4 in which the indicating weight further comprises a slit in open communication with the peg opening and extending away from the peg.

6. The indicator of claim 5 in which the slit terminates in open communication with a distal opening.

7. The indicator of claim 4 further comprising a transparent cover extending over and in contact with the spacer and peg.

8. The indicator of claim 7 in which the cover is at least partially removable.

9. The indicator of claim 7 in which the side of the base opposite the side to which the indicating weight is attached to the peg bears an adhesive.

10. The indicator of claim 7 in which the indicating weight is attached to the base by a securing means to guard against a premature detachment of the weight from the peg.

11. The indicator of claim 10 in which the securing means is a pin.

12. The indicator of claim 1 in which the base and indicating weight are of different colors.

13. The indicator of claim 1 in which the base and spacer are a single, molded piece.

14. The indicator of claim 1 in which the base, peg and spacer are a single, molded piece.

15. The indicator of claim 1 in which the indicating weight is free to rotate 360 degrees about the peg.

16. An article comprising the indicator of claim 1.

17. The article of claim 15 in which the article is a shipping container.

18. A shock indicator comprising:
A. A base;
B. A peg affixed to the base; and
C. An indicating weight comprising a peg opening and a gap, the weight attached to the peg at the peg opening such that the weight is not free to substantially rotate about the peg, and the weight will not detach from the peg in the absence of experiencing a shock of at least a predetermined level of force from a predetermined direction.

19. The indicator of claim 18 further comprising a spacer attached to the base, and forming with the base a cavity within which is located the indicating weight.

20. An article comprising the indicator of claim 18.
